(19) United States
(12) Patent Application Publication
(10) Pub. No.: US 2003/0104174 A1
(43) Pub. Date: Jun. 5, 2003

(54) Scratch card

(76) Inventors: Tetsuyuki Itakura, Tokyo (JP); Rei Takeuchi, Tokyo (JP); Hiroshi Yagi, Tokyo (JP)

Correspondence Address: F. William McLaughlin, Wood, Phillips, Vansanten, Clark & Mortimer, Suite 3800, 500 West Madison St., Chicago, IL, 60661, US

(21) Appl. No.: 10/062,856

(22) Filed: Jan. 31, 2002

(30) Foreign Application Priority Data
Oct. 26, 2001 (JP) 2001-328517

(51) Int. Cl. B32B 3/00

(52) U.S. Cl. 428/195

(57) ABSTRACT

A scratch card is provided comprising a substrate, a layer containing information to be concealed, a slipping layer and a concealing layer, laminated in this order, wherein said concealing layer essentially composed of concealing pigment and a binder. With this composition, easy removal by nails and coins is possible, while the removal does not generate latex dust.

### APPLICATION FIELD IN INDUSTRY

The present invention relates to a scratch card wherein, when a concealing layer on a slipping layer is removed to expose the concealed information, latex dust stays on the card and they do not adhere to the roller or the like in a reading machine, thereby allowing the card to be read with the machine without misreading, as well as providing a high-security function.

### BACKGROUND ART

A scratch card has been well known in the art wherein a concealing layer on a slipping layer is scraped off such that concealed information, such as letters, numerals, pictures, recorded (by printing or the like) under the slipping layer can be seen (Japanese Utility Model Kokoku No. 2-3897, Japanese Patent Application Kokai Nos. 2-297,482 and 10-264,565).

Japanese Utility Model Kokoku No. 2-3897 discloses a scratch type lottery comprising a paper or a plastic substrate, a metal layer, a layer containing information (e.g. pictures), and a concealing layer which is scratchable (or has removable property), laminated in this order. With respect to the ink used in the information layer, an acrylic resin is used as a vehicle in order to promote easy removal of the concealing layer formed on the information layer. For the ink used in the concealing layer, at least one member selected from natural rubber resins such as natural rubber and rubber hydrochloride and synthetic rubber resins, for example, diene resins such as polybutadiene, styrene-butadiene copolymer, acrylonitrile-butadiene copolymer, polyisoprene, polychloroprene, is used as a vehicle, which render removability to the concealing layer. For securing concealment, a metal powder, a coloring agent or the like are used.

Japanese Patent Application Kokai No. 2-297,482 discloses a scratch-removable printed matter comprising a paper substrate, a layer containing information (e.g. picture), a UV-curable resin layer and a scratchable concealing layer, laminated in this order. The above document mentioned that, in order to improve removability of the concealing layer formed on the surface of the UV-curable resin layer, a slip agent is added to the UV-curable resin layer. However, there is no further description about the concealing layer.

Japanese Patent Application Kokai No. 10-264,565 discloses a scratchable printed matter comprising a paper substrate, a layer containing information (such as bar code and pictures), a plastic film layer and a scratchable concealing layer, laminated in this order. A plastic film layer imparts a further scratchability (easy-rupturing property and removability) to the concealing layer on it and is formed of a polypropylene resin, an acrylic resin, polyvinyl chloride, polyethylene, polyethylene terphthalate, nylon, cellophane or a complex resin thereof. With respect to the concealing layer, the materials mentioned in the document as a scratchable resin is a blend of at least two resins selected from polyethylene, ethylene-vinyl acetate copolymer, polypropylene, polystyrene, styrene copolymer, styrene-butadiene rubber, various waxes, rosin, a terpene resin and terpene polymer. For the purpose of improving the concealing property of the concealing layer, the layer further contains a metal flake powder dispersed therein, which exhibits golden or silver color in the final product. Due to the light absorption and reflection of the metal powder, the concealing effect of the layer is further improved.

Accordingly, in the prior art, attempts have been made to obtain a concealing layer on a slipping layer, which can be easily removed by coins, nails or the like, by adding a slip agent to the slipping layer, so that the adhesion of the slipping layer to the concealing layer is lowered, as well as by forming the concealing layer with an ink comprising rubber resin(s) or blend resin and a fine metal powder dispersed in the resin. In addition, by utilizing light absorption and reflection of the metal fine powder, visual reading or optical machine reading of the concealed information is prevented, before scratching the card.

### THE PROBLEM TO BE SOLVED BY THE INVENTION

However, the prior arts have problems in that latex dust is generated after the concealing layer was scratched. In other words, in the prior art, the concealing layer can be removed easily by means such as coins and nails, but as the result of the removal of the concealing layer on the slipping layer by the scratching, latex dust which is detached from the scratch card are generated. When such a card with latex dust is read in a machine, latex dust adheres to the card from which the debris is derived, or to the other card via the roller inside the machine, which may result in misreading of the card by the machine.

In addition, latex dust has adverse effect on the environment, and therefore, the use of such scratch cards in restaurants, supermarkets or the like are not desired from the viewpoint of hygiene.

Further, when the card is read with a machine and latex dust is present at the site of the reading, it may result in misreading of the card.

The present invention aims at solving at least one of these problems.

### MEANS TO SOLVE THE PROBLEM

To solve these problems, the present invention provides the following scratch card.

(1) A scratch card comprising a substrate, a layer containing information to be concealed, an slipping layer and a concealing layer, laminated in this order, said concealing layer comprising a concealing pigment and a binder, characterized in that said concealing layer is easily removable with a scratching means but free latex dust is prevented from being formed.

(2) The scratch according to (1) above wherein the concealing layer has easy-rupture property and self-tackiness.

(3) The scratch card according to (1) or (2) above, wherein a tackiness layer is present between said slipping layer and said concealing layer.

(4) The scratch card according to (3) above, wherein said tackiness layer contains the same binder as used in said concealing layer at least in an area to be scratched by said scratching means.

(5) The scratch card according to any (1) to (4) above, wherein said card further comprises a layer selected from a non-tacky protective layer and a printing layer on said concealing layer.

(6) The scratch card according to (2) above, wherein said concealing layer contains at least a tackiness agent selected from acrylic ester, polymer of acrylic ester, polyvinyl ether and a silicone resin.

(7) The scratch card according to (3) above, wherein said tackiness layer contains at least a tackiness agent selected from a rubber tackiness agent, a diene tackiness agent, acrylic ester and polymer of acrylic ester, polyvinyl ether and a silicone resin.

These constructions of the present invention have advantages over the prior art in that the concealing layer can be easily removed by nails or coins, and at the same time, no free latex dust is generated.

As mentioned above, when the concealing layer has tackiness in itself, the tackiness layer may or may not be present between the slipping layer and the concealing layer.

However, when the concealing layer does not have tackiness in itself, the tackiness layer should be present between the slipping layer and the concealing layer.

### BEST MODE FOR CARRYING OUT THE INVENTION

In order for forming a scratch card by lamination, the components and the requisite properties for each layer will be explained below.

Layer Containing Information to be Concealed (Secret Information Layer)

The secret information layer is a layer containing letters, numerals, bar code, pictures or the like. The layer is formed by printing or similar means on the substrate, such as paper, synthetic paper, plastic (e.g. PET), glass and metal. The method for forming the secret information layer varies depending on whether the secret information is fixed or varied. When the secret information is fixed, any conventional printing methods can be applied. Examples include silk-screen printing and offset printing. When the secret information is varied, there is no specific limitation with respect to the printing method as long as the printing method allows the secret information to be changed in the course of printing. Examples of such printing method include ink-jet printing.

Slipping Layer

As a slipping layer, any layer can be utilized as long as the layer lowers the tackiness between the information layer on the card and the concealing layer or the tackiness layer, and the slipping layer provides easiness in removing and rupturing the concealing layer. Examples include a resin containing a slip agent (a substance exhibiting easy release), such as silicone oil. As the method for forming the slipping layer, any conventional printing methods can be applied. Examples include silk-screen printing and offset printing. When the production efficiency is taken into account, it is preferred that the ink made of a UV resin containing silicone oil be used, and offset printing and UV-curing be conducted.

Tackiness Layer

When the amount of metal powder, such as aluminum powder, added to the concealing layer is increased for the purpose of enhancing the concealability, self-tackiness is lowered. The presence of the tackiness layer compensates for low tackiness of the concealing layer, and the generation of free debris can be prevented due to the self-tackiness provided by the tackiness layer.

With respect to the resin to be used for the tackiness layer, there is no specific limitation as long as the resin has high tackiness and is easily ruptured by scratching with coins and nails. A tackiness agent has a viscosity enough to adhere to a surface with a weak force, such as digital compression, and has elasticity enough to tolerate the external force such as peeling and shearing force. Accordingly, the tackiness agent is composed of an elastic body as a main component and a tackifier or a plasticizer that are compatible with the elastic body. Examples of the elastic body as the main component of the tackiness agent include natural rubber, polybutadiene, styrene-butadiene rubber, acrylonitrile-butadiene rubber, polyisoprene, polychloroprene, polyisoprene-polyisobutylene, thiol rubber, acrylic ester and a polymer thereof, polyvinyl ether, a silicone resin or the like. With respect to the rubber tackiness agent and diene tackiness agent, rosin or a terpene resin is added as a tackifier, in order to add tackiness. The above-mentioned acrylic ester is a copolymer mainly composed of acrylic ester of C2-12 aliphatic alcohol, which can be obtained by co-polymerizing the acrylic ester with a small amount of monomer having polar functional groups, such as acrylic acid and acrylic amide. The resultant copolymer is viscous; the degree of the polymerization is high; the copolymer is likely to have rubber elasticity; and it may have various functions since the distribution of the copolymer is wide due to wide chemical composition distribution and molecular weight distribution. As the result, acrylic ester alone can function as an elastic body, a tackifier and a plasticizer. Especially acrylic ester or polymer thereof is advantageous to achieve the object of the present invention, because of its high tackiness.

As the method for forming the tackiness layer, any conventional printing methods can be applied. Examples include silk-screen printing and offset printing. In these methods, ink obtained by diluting a tackiness agent with a solvent or the like is used, in order to make the tackiness agent appropriate for the printing. There is no specific limitation with respect to the solvent, as long as the tackiness agent can be dissolved in it. However, a solvent having a high-boiling point is preferred, since the evaporation of the solvent is slow upon printing and the thickness of the printing is kept stable. Examples of the high-boiling solvent includes ketone isophorone, aromatic diethylbenzene and the mixture thereof.

Concealing Layer

There are two states of the concealing layer: the layer itself has high-tackiness; or has low self-tackiness. In the former case, the tackiness layer is not necessary. However, when the concealing materials, such as metal powder are used, the tackiness of the concealing layer becomes poor, and thus it is preferred that the above-mentioned tackiness layer is provided. In the present invention, as shown above, the concealing layer itself, or together with the tackiness layer, prevents the generation of latex dust.

In the concealing layer, the same resin as used in the tackiness layer can be used, or the resin having the equivalent properties can be used. In addition, the secret information under the concealing layer should be kept concealed before scratching, and therefore the pigment to be dispersed in the above-mentioned resin should be selected so as to conceal the information of the lower layer. Examples of such material include metal fine powder, such as metal aluminum; black pigment, such as carbon black; and white pigment, such as titanium oxide. As the method for forming the concealing layer, any conventional methods can be applied. Examples include silk-screen printing and offset printing.

White Layer

A white layer is preferably provided between the concealing layer and the printing layer, when the formation of the printing layer is required on the concealing layer, and the improvement of the contrast of the printing is desired. With respect to the resin used in the white layer, there is no specific limitation as long as the resin has equivalent properties to that of the resin used in the tackiness layer. In addition, the pigment to be dispersed in the above-mentioned resin should be selected so as to improve the contrast of the printing. Examples of such material include white pigment, such as titanium oxide. As the method for forming the white layer, anyl conventional methods can be applied. Examples include silk-screen printing and offset printing.

Protective Layer

The purpose for providing a protective layer is to protect the concealing layer, especially the concealing layer having high tackiness, since it is likely to have flaws and to catch dust. In the protective layer, transparent resins having non-tackiness (anti-tackiness) and non-blocking property, or color ink to form pictures can be used. Examples of such materials include a UV-curable resin; a solvent type thermoplastic resin, such as a vinyl chloride-vinyl acetate copolymer resin, an acrylic ester-styrene copolymer resin, nitrocellulose, a maleic resin; a water-soluble resin, such as polyvinyl alcohol, polycarboxylate, polyvinyl pyrrolidone; and resins which can be in the form of colloidal dispersion and emulsion, such as various acrylic copolymer resins and polyurethane. As the material for forming pictures, the conventional color inks can be used.

As the methods for forming the protective layer and the printing layer, any conventional printing method can be applied. Examples include silk-screen printing and offset printing.

Barrier Layer

The tackiness layer is fragile and likely to have flaw, and exhibits poor plasticity resistance and poor solvent resistance. In addition, the concealing layer, especially those containing the same resin type as the tackiness layer does, has difficulty in covering the tackiness layer. Therefore, a barrier layer that does not have adverse effect on the tackiness layer is preferably provided between the tackiness layer and the concealing layer. In such a barrier layer, a rein or a cross-linking type resin that exhibits solvent resistance as well as softness is used. For example, resins such as PVA cross-linking type, polyurethane-epoxy cross-linking type, UV cross-linking type can be advantageously used as a binder to increase cross-link density and molecular weight between cross-linking points.

As shown above, in the present invention, a concealing layer having self-tackiness is provided on a slipping layer. Alternatively, an tackiness layer is provided on a slipping layer, and the concealing layer having less self-tackiness is provided on the tackiness layer. As the result, when the card is scratched, a scratched part of the slipping layer is removed and scratched film becomes, but the latex dust stays on the card due to its tackiness.

By providing the concealing layer with self-tackiness, or by introducing an tackiness layer on the slipping layer, the adhered film is easily ruptured when scratched. The ruptured film portion does not leave the card and is adhered to the film itself, because of tackiness of the tackiness layer, resulting in the accumulation of latex dust on the margins of the scratched part.

The easiness of rupturing of the tackiness film is associated with the rupturing stress to the film. Another significant factor is the cohesiveness with the lower layer, and the lowering of the cohesiveness by introducing a slipping layer supports easy rupture.

By forming a protective layer having non-tackiness as the uppermost layer, the scratched portion of the film does not adhere to coins or nails used for scratching. In addition, when the card is read using a machine, the debris does not adhere to the scanner or the convey roller in the reading machine. Further, the protective layer provides the protection from scraping during manufacture, transportation and storage of the card.

### EXAMPLES

The present invention will be described with reference to the following

### EXAMPLES AND COMPARATIVE EXAMPLE

### Example 1 and Comparative Example

In this example, a concealing layer having self-tackiness was used, and an tackiness layer was not introduced. A substrate, a slipping layer, a concealing layer and a protective layer (print-laminated in this order) each having the components shown in Table 1 were used, and scratch cards were prepared for Example and Comparative Example.

TABLE 1

| | Thickness | | Forming | | Solid |
|---|---|---|---|---|---|
| | (μm) | Material | method | Diluent | content |
| Protective | 0.5 | PVA (*1) | roll coating | water | 10% |
| layer | | | | | |
| Concealing | 10.0 | (*2) | roll coating | MEK- | 20% |
| layer | | | | toluene | |
| | | | | (1:1) | |
| Slipping | 1.0 | UV ink | offset | — | — |
| layer | | (*3) | printing | | |
| Substrate | 230 | paper (*4) | — | — | — |

*1) Protective layer
Gohsenol KP106 (trade name) manufactured by The Nippon Synthetic Chemical Industry Co.
*2) Concealing layer for the present invention
Binder: acrylic tackiness agent PBS5896 (trade name) manufactured by Toyo Ink Co.
Metal powder: metal aluminum Alpaste 1200T (trade name) manufactured by Toyo Aluminum K. K.
Solid weight ratio: metal powder/binder = 4/6
It should be noted that large ratio of metal powder/binder was applied in order to improve tackiness.
Concealing layer for Comparative Example (Prior art)
Ink: SS lottery silver ink (components are as follows) manufactured by Toyo Ink Co.
Binder: styrene-butadiene copolymer
Metal powder: metal aluminum
Solid weight ratio: metal powder/binder = 6/4
*3) Slipping layer
New Z removal OP varnish (trade name) manufactured by Dainippon Ink And Chemicals, Inc.
*4) Substrate
F1 (210 g/m²) manufactured by Daishowa Paper Mfg. Co.

With respect to the resultant scratch cards, scratching tests were conducted. With respect to the conventional card, minute latex dust was generated and fell from the card. On the other hand, with respect to the card of the present invention, latex dust was accumulated on the margin of the scratched portion and stayed on the card.

In addition, another specimen of the present invention containing the same components in the above-mentioned Table 1 was prepared, except that two different acrylic adhesives [SK Dyne 1717 and SK Dyne 1606 (trade name), manufactured by Soken Chemical & Engineering Co.] were used as binder instead of the binder in Table 1. The result of the scratching test was similar to that of the above-mentioned specimen of the present invention.

### Example 2

In this Example, an tackiness layer was introduced between a slipping layer and a concealing layer. The components are shown in Table 2. For the tackiness layer, an acrylic tackiness agent BPS5896 (trade name, manufactured by Toyo Ink Co.) was used, and a barrier layer using PVA was introduced in order to protect the tackiness layer.

TABLE 2

| | Thickness | | Forming | | Solid |
|---|---|---|---|---|---|
| | (μm) | Material | method | Diluent | content |
| Protective | 1.0 | PVA (*1) | roll coating | water | 10% |
| layer | | | | | |
| Concealing | 6.0 | (*2) | roll coating | MEK- | 20% |
| layer | | | | toluene | |
| | | | | (1:1) | |
| Barrier | 1.0 | PVA (*1) | roll coating | water | 10% |
| layer | | | | | |
| Tackiness | 6.0 | acrylic | roll coating | MEK- | 20% |
| layer | | tackiness | | toluene | |
| | | agent (*5) | | (1:1) | |
| Slipping | 1.0 | UV ink (*3) | offset | — | — |
| layer | | | printing | | |
| Substrate | 230 | paper (*4) | — | — | — |

* 1) Protective layer
Gohsenol KP106 (trade name) manufactured by The Nippon Synthetic Chemical Industry Co.
*2) Concealing layer of the present invention
Binder: acrylic tackiness agent BPS5896 (trade name) manufactured by Toyo Ink Co.
Metal powder: metal aluminum Alpaste 1200T (trade name) manufactured by Toyo Aluminum K. K.
Solid weight ratio: metal powder/binder = 6/4
*3) Slipping layer
New Z removal OP varnish (trade name) manufactured by Dainippon Ink And Chemicals, Inc.
*4) Substrate
Fl (210 g/m²) manufactured by Daishowa Paper Mfg. Co.
*5) Tackiness layer
Acrylic tackiness agent BPS5896 (trade name) manufactured by Toyo Ink Co.

With respect to the resultant scratch card, scratching test was conducted. Latex dust was accumulated on the margin of the scratched portion and stayed on the card. In this Example, the amount of the tackiness agent in the concealing layer was lowered, but excellent feature was attained because of the introduction of the tackiness layer.

### Example 3

In this Example, the same scratch card as in Example 2 was prepared, except that the concealing layer of the prior art in Example 1 was used instead. Therefore in this Example, the scratched card of the present invention exhibiting excellent scratchability, in which the conventional concealing layer is used in combination with the tackiness layer, is illustrated. The components and forming methods are shown in Table 3.

TABLE 3

| | Thickness | | Forming | | Solid |
|---|---|---|---|---|---|
| | (μm) | Material | method | Diluent | content |
| Protective | 1.0 | PVA (*1) | roll coating | water | 10% |
| layer | | | | | |
| Concealing | 6.0 | (*2) | roll coating | — | — |
| layer | | | | | |
| Barrier | 1.0 | PVA (*1) | roll coating | water | 10% |
| layer | | | | | |
| Tackiness | 6.0 | acrylic | roll coating | MEK- | 20% |
| layer | | tackiness | | toluene | |
| | | agent (*5) | | (1:1) | |
| Slipping | 1.0 | UV ink | offset | — | — |
| layer | | (*3) | printing | | |
| Substrate | 230 | paper (*4) | — | — | — |

*1) Protective layer and barrier layer
Gohsenol KP106 (trade name) manufactured by The Nippon Synthetic Chemical Industry Co.
*2) Concealing layer
Ink: SS lottery silver ink (components are as follows) manufactured by Toyo Ink Co.
Binder: styrene-butadiene copolymer
Metal powder: metal aluminum
Solid weight ratio: metal powder/binder = 6/4
*3) Slipping layer
New Z removal OP varnish (trade name) manufactured by Dainippon Ink And Chemicals, Inc.
*4) Substrate
F1 (210 g/m²) manufactured by Daishowa Paper Mfg. Co.
*5) Tackiness layer
Acrylic tackiness agent BPS5896 (trade name) manufactured by Toyo Ink Co.

With respect to the resultant scratch card, scratching test was conducted. The latex dust on the margin of the scratched portion exhibited less tackiness as compared with that in Example 2, however, the debris stayed on the card.

### Example 4

The same samples as in Examples 1-3 were obtained, except that the paper substrate was changed to PET having a thickness of 188 μm, and the same scratching tests were conducted. The results were similar to those in Examples 1-3. The reason for this is believed that, the substrate did not have effect on the tackiness layers or the like, since the layers were indirectly formed on the substrate via the slipping layer.

### Example 5

In this Example, a barrier layer, a white layer and a printing layer were formed in this order on the concealing layer, in order to print patterns. The components are shown in Table 4.

TABLE 4

| | Thickness | | |
|---|---|---|---|
| | (μm) | Material | Forming method |
| Printing layer | 1.0 | UV color ink (*6) | offset printing |
| White layer | 5.0 | titanium oxide resin | silk-screen printing |
| | | (*7) | |
| Barrier layer | 1.0 | aqueous UV (*1) | silk-screen printing |
| Concealing | 6.0 | (*2) | silk-screen printing |
| layer | | | |
| Barrier layer | 1.0 | aqueous UV (*1) | silk-screen printing |
| Tackiness | 10.0 | acrylic tackiness agent | silk-screen printing |
| layer | | (*5) | |
| Slipping layer | 1.0 | UV ink (*3) | offset printing |
| Information | 1.0 | ink-jet aqueous ink | ink-jet printing |
| layer | | | |
| Substrate | 230 | paper (*4) | — |

*1) Barrier layer
Aqueous UV component: urethane acrylate EM92 (solid content 40 weight %) manufactured by Arakawa Chemical Industries
Photo-initiator: Irgacure 184 (trade name) manufactured by Ciba-Geigy, 5 phr was added relative to the resin
*2) Concealing layer
Binder: acrylic tackiness agent BPS5896 (trade name) manufactured by Toyo Ink Co.
Metal powder: metal aluminum Alpaste 1200T (trade name) manufactured by Toyo Aluminum K. K.
Solid weight ratio: metal powder/binder = 6/4
*3) Slipping layer
New Z removal OP varnish (trade name) manufactured by Dainippon Ink And Chemicals, Inc.
*4) Substrate
F1 (210 g/m²) manufactured by Daishowa Paper Mfg. Co.
*5) Tackiness layer
Acrylic tackiness agent BPS5896 (trade name) manufactured by Toyo Ink Co.
*6) Printing layer
UV color ink, Karton 4C (trade name) manufactured by Toyo Ink Co.
*7) White layer
White powder: titanium oxide, R930 (trade name) manufactured by Ishihara Sangyo Kaisha
Resin: acrylic tackiness agent, BPS5896 manufactured by Toyo Ink Co.
Solid weight ratio: white powder/resin = 6/4

With respect to the resultant scratch card, scratching test was conducted. Excellent scratchability (easy-rupturing property) was obtained. The adhesion of latex dust on the margin of the scratched portion was also excellent, and no blocking occurred when the plurality of cards was piled.

[Effect]

As is apparent from the above, according to the present invention, latex dust derived from the removal of a slipping layer by coins and nails does not leave the card nor attached to the coins and nails. Therefore, it is advantageous to use such scratch card where hygiene is important. When concealing information is exposed by scratching the card and read using a machine, possible problems of misreading caused by latex dust can be avoided and precise reading with the machine is attained, since the debris does not adhere to the reading machine.

What we claim is:

1. A scratch card comprising a substrate, a layer containing information to be concealed, a slipping layer and a concealing layer, laminated in this order, said concealing layer comprising a concealing pigment and a binder, characterized in that said concealing layer is easy removable with a scratching means but free latex dust is prevented from being formed.

2. The scratch card according to claim 1, wherein said concealing layer has easy-rupture property and self-tackiness.

3. The scratch card according to claim 1 or 2, wherein a tackiness layer is present between said slipping layer and said concealing layer.

4. The scratch card according to claim 3, wherein said tackiness layer contains the same binder as used in said concealing layer at least in an area to be scratched by said scratching means.

5. The scratch card according to any one of claims 1 to 4, wherein said card further comprises a layer selected from a non-tacky protective layer and a printing layer on said concealing layer.

6. The scratch card according to claim 2, wherein said concealing layer contains at least a tackiness agent selected from acrylic ester, polymer of acrylic ester, polyvinyl ether and a silicone resin.

7. The scratch card according to claim 3, wherein said tackiness layer contains at least a tackiness agent selected from a rubber tackiness agent, a diene tackiness agent, acrylic ester and polymer of acrylic ester, polyvinyl ether and a silicone resin.
